(19) United States
(12) Patent Application Publication
(10) Pub. No.: US 2002/0056133 A1
(43) Pub. Date: May 9, 2002

(54) Synchronization for digital cable network

(76) Inventors: Danny Fung, Walnut, CA (US); Mohammad Usman, Mission Viejo, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/798,539

(22) Filed: Mar. 2, 2001

Related U.S. Application Data
(60) Provisional application No. 60/186,733, filed on Mar. 3, 2000.
(60) Provisional application No. 60/195,015, filed on Apr. 6, 2000.

(51) Int. Cl. H04N 7/173

(52) U.S. Cl. 725/118

(57) ABSTRACT

A communication system, such as a digital cable network, achieves synchronization using data rate synchronization, clock frequency synchronization, or clock recovery synchronization techniques. The communication system includes a conversion clock at a transmitter and a conversion clock at a receiver. The data rate synchronization techniques adjust data rates by resampling digital data sent from the transmitter to the receiver to compensate for frequency variations in the conversion clocks. The clock frequency synchronization techniques use time stamps to adjust the receiver conversion clock frequency to substantially match the transmitter conversion clock frequency. The clock recovery techniques use a reference clock to adjust the transmitter conversion clock frequency and the receiver conversion clock frequency to be approximately the same.

### RELATED APPLICATIONS

The present application claims priority to co-pending provisional application entitled METHOD AND APPARATUS FOR DATA RATE SYNCHRONIZATION, application Ser. No. 60/186,733, filed Mar. 3, 2000, and to co-pending provisional application entitled SYNCHRONIZATION FOR DIGITAL CABLE NETWORK, application Ser. No. 60/195,015, filed Apr. 6, 2000, which are hereby incorporated by reference in their entirety.

### BACKGROUND OF THE INVENTION

1. Field of the Invention

This invention relates generally to digital signal processing, and more specifically to data synchronization in a digital cable television network.

2. Description of the Related Art

The conventional function of a cable television (CATV) network is to broadcast a maximum number of television channels to subscribers at a minimum cost. Consequently, the flow of information is: asymmetric; transmitted as analog broadband signals; and is relatively unreliable. A growing demand for advanced services (e.g., voice, video on demand, data, etc.) over the CATV network is driving the evolution of advanced CATV network architectures (e.g., Multiplexed Fiber Passive Coax), which provide more reliability and network powering for lifeline services. Further, cost-effective methods are being introduced to convert the analog CATV network into a digital network capable of providing high-speed, wide-bandwidth, highly scaleable, flexible and reliable services.

Digital techniques are used to reliably and securely communicate information. Real-life information (e.g., speech, music, video, etc.) is produced and perceived as analog signals (i.e., time-continuous signals). The real-life information is sampled and digitized at a transmitter, and the digitized information is converted back to the analog signals at a receiver of a digital communication system.

The digital network, using digital transmission, provides cost and performance improvements over analog transmission. Digital transmission, using techniques such as total network management, improves the reliability and security of the network. Digital transmission typically requires analog signals to be digitized by an Analog-to-Digital Converter (ADC) at a transmitter. A Digital-to-Analog Converter (DAC) at a receiver converts the digitized signals back to analog forms. To properly recover the signals at the receiver, the rate at which the analog signals are digitized is usually synchronous with the rate at which the digitized signals are converted back to analog forms.

The ADC samples and digitizes analog signals, and the DAC converts digitized signals to analog signals. To avoid distortion, the rate at which information is digitized (the data generation rate) is synchronous with the rate at which the digitized information is converted to analog signals (the data consumption rate). A difference between the data generation rate and the data consumption rate results in a spectral expansion or a spectral compression of the information at the receiver. A difference between the data generation rate and the data consumption rate also typically results in a shortage or an excess of digital samples to be present at the DAC input which causes the DAC buffer to under-run or over-run.

The ADC and the DAC operations are controlled by respective conversion clocks. An off-the-shelf crystal oscillator for generation of the conversion clock is typically accurate to within ±100 parts-per-million (ppm) of its stated frequency. If the ADC and the DAC each use similar crystal oscillators, the worst case disparity between their respective conversion clock frequencies is ±200 ppm.

Although the disparity between the conversion clock frequencies appears to be slight, the relative time represented by each clock eventually becomes significant. The disparity can produce unacceptable distortion when the signal spectrum stretches or compresses at the receiver. In addition, the DAC buffer can over-run or under-run when the DAC conversion clock runs slower or faster than the ADC conversion clock.

### SUMMARY OF THE INVENTION

The present invention solves these and other problems by providing simple and cost-effective local synchronization in a digital CATV network. Local synchronization allows each transmitter and each receiver in the digital CATV network to be locally synchronized. For example, a transmitter and a receiver in a communication network can have independent oscillators (i.e., clocks) to operate an ADC and a DAC respectively. Various techniques are used to prevent distortions caused by disparities between the independent oscillators.

In one embodiment, data rate synchronization techniques adjust data rates to compensate for frequency variations in conversion clocks. A communication system (e.g., a digital CATV network) includes a conversion clock at a transmitter and a conversion clock at a receiver that advance respective counters. A difference between the counters controls a resampling of digital data sent from the transmitter to the receiver. The conversion clocks run independently of each other. The difference between the counters incremented by respective conversion clocks provides an indication of the difference in frequencies between the conversion clocks. The difference is used to determine the ratio at which digitized information is resampled at the receiver before being converted to the analog domain. Proper resampling (i.e., data rate adjustment) avoids a shortage or an excess of digital samples at a DAC input when the frequencies of the respective conversion clocks differ.

The receiver determines a resampling ratio based on a difference between an ADC conversion clock frequency and a DAC conversion clock frequency. In one embodiment, the transmitter and the receiver include respective counters. The transmitter counter is incremented by the ADC conversion clock (or some multiple thereof) and the receiver counter is incremented by the DAC conversion clock (or some multiple thereof). The counters count cumulatively and wrap when a maximum number is reached. The receiver receives an indication of the ADC conversion clock frequency from a cumulative count incremented by the ADC conversion clock. Cumulative counts are sent to the receiver intermittently or periodically with data (e.g., data packet). The receiver extracts the ADC cumulative counts from the received data.

In one embodiment, the receiver compares a current ADC cumulative count with a previous ADC cumulative count stored in memory. The receiver similarly compares a current DAC cumulative count with a previous DAC cumulative count stored in memory. When the ADC conversion clock is synchronous with the DAC conversion clock, the rates of change in their respective cumulative counts are the same. When the ADC conversion clock frequency and the DAC conversion clock frequency are different from each other, the rates of change in their respective cumulative counts drift apart. The amount of drift between the rates of change corresponds to the amount of difference between the ADC and the DAC conversion clock frequencies.

In an alternate embodiment, the receiver compares the current ADC cumulative count with the current DAC cumulative count. When the ADC conversion clock is synchronous with the DAC conversion clock, the difference is zero or a fixed amount each time. When the ADC conversion clock and the DAC conversion clock frequencies are different from each other, the difference between the cumulative counts varies. The variation of the difference between the cumulative counts provides the receiver with an indication of the difference between the ADC conversion clock frequency and the DAC conversion clock frequency.

Resampling compensates for the disparity between the ADC conversion clock frequency and the DAC conversion clock frequency. Resampling involves decimation and/or interpolation of data. A resampler takes input data at one rate and generates output data at another rate. A control word or a control signal is provided to the resampler to control the ratio of the input data rate to the output data rate. In one embodiment, the control word is derived from the difference between the rate of change in the ADC cumulative count and the rate of change in the DAC cumulative count. In an alternate embodiment, the control word is derived from the variation of differences between the current ADC cumulative counts and the current DAC cumulative counts.

In one embodiment, data rate synchronization is used in a cable television distribution system. Analog video channels are sampled digitally at a transmitter for transmission through a communication channel. The digitized samples are converted back to the analog format at a receiver. Analog video channels have bandwidths of approximately 6 Mega-Hertz (MHz) each. In one embodiment, each analog video channel is digitized by a respective ADC. The conversion clocks of respective ADCs function independently of each other. Accordingly, each conversion clock increments a respective counter.

In preparation for transmission, the digitized data for each analog video channel is framed (i.e., arranged in a specified order) and combined with other digital information (e.g., other digitized analog video channels and digital video channels) using Time Division Multiplexing (TDM). During the framing process, the cumulative counts of respective counters are added to the respective frames for transmission to the receiver. Fiber optic cables or coaxial cables can be used for the transmission.

The receiver demultiplexes the incoming TDM signal back into the individual frames. The cumulative counts are extracted from the respective frames during the deframing process when digitized channels are recovered. The cumulative counts are provided to respective control circuits while the digitized channels are provided to respective resamplers. The resampled data at the outputs of respective resamplers are combined by a bank of modulators using frequency division multiplexing. The combined digital signal is converted to an analog signal using a DAC. The analog signal can be further processed and transmitted to subscribers.

The DAC is controlled by a conversion clock. The DAC conversion clock (or some multiple thereof) increments a counter. The value of the counter is provided to the control circuits which output appropriate control words or control signals to the respective resamplers using methods discussed above.

In one embodiment, a common conversion clock controls the operations of ADCs in a transmitter. The common conversion clock also controls a transmitter synchronization circuit. The output (i.e., transmitter time stamp) of the transmitter synchronization circuit is provided to a multiplexer for combination with data signals into one transport stream that is transmitted to a receiver.

The receiver includes a demultiplexer that separates the incoming transport stream into individual data streams and extracts the transmitter time stamp. The transmitter time stamp is provided to a receiver synchronization circuit which also receives a receiver time stamp derived from a receiver conversion clock. The receiver synchronization circuit provides an appropriate control signal to resample the individual data streams to compensate for a frequency difference between the common conversion clock in the transmitter and the receiver conversion clock.

In one embodiment, the data rate is adjusted to account for disparities that develop between a transmitter clock frequency and a receiver clock frequency in a digital CATV network. In the digital CATV network, analog video channels are digitized at a transmitter and converted back to the analog format at a receiver. A transmitter clock controls the rate at which the analog video channel is digitized (i.e., data generation rate) by an ADC. The transmitter clock (or some multiple thereof) simultaneously advances a transmitter counter.

The value of the transmitter counter is sent to the receiver at regular intervals or intermittently with data streams. A receiver clock (or some multiple thereof), which controls the rate at which the digitized video channel is converted to analog signals (i.e., data consumption rate), advances a receiver counter. The values of the transmitter and receiver counters flnction as time stamps and provide an indication of the disparity between the transmitter clock frequency and the receiver clock frequency.

To determine the level of disparity between the transmitter clock frequency and the receiver clock frequency, the receiver compares the values of the transmitter counter and the receiver counter. The result of the comparison is used to determine the ratio at which the digitized video channel is resampled at the receiver before being converted to the analog domain by the DAC. Resampling alters the sampling rate of the incoming bit stream. Proper resampling improves the accuracy of analog signals at the output of the DAC and reduces distortion caused by the disparity between the transmitter clock frequency and the receiver clock frequency.

The time stamp flnctions and the resampler can be advantageously implemented in a Digital Signal Processor (DSP). In one embodiment, the receiver compares a current receiver time stamp with a previous receiver time stamp stored in memory. The receiver similarly compares a current transmitter time stamp with a previous transmitter time stamp. When the transmitter clock frequency is the same as the receiver clock frequency, the rates of change in their respective time stamps are the same. When the transmitter clock frequency and the receiver clock frequency are different from each other, the rates of change in their respective time stamps drift apart. The amount of drift between the rates of change corresponds to the amount of difference between the transmitter and the receiver clock frequencies.

In one embodiment, the receiver compares the current transmitter time stamp with the current receiver time stamp. When the transmitter clock frequency is the same as the receiver clock frequency, the difference is zero or a fixed amount each time. When the transmitter clock frequency and the receiver clock frequency are different from each other, the difference between the time stamps varies. The variation of the difference between the time stamps provides the receiver with an indication of the difference between the transmitter clock frequency and the receiver clock frequency.

In one embodiment, clock frequency synchronization techniques is used for synchronizing respective clocks in a transmitter and a receiver. The transmitter sends time stamps indicative of the transmitter clock frequency to the receiver. The receiver uses the information derived from the time stamps to adjust the receiver clock frequency to substantially match the frequency of the transmitter clock. The time stamps are compared in similar methods as described above and the resulting magnitudes determine the amount of adjustment to the receiver clock. For example, the receiver clock frequency increases when the transmitter time stamp increases at a faster rate than the receiver time stamp, and the receiver clock frequency decreases when the transmitter time stamp increases at a slower rate than the receiver time stamp.

In one embodiment, clock recovery techniques synchronize respective clocks in a transmitter and a receiver. A reference clock is used to adjust the transmitter clock frequency and the receiver clock frequency to be approximately the same. The reference clock is a Program Clock Reference (PCR) which is generated at the transmitter and sent to the receiver as part of a data stream in a communication system, such as a digital CATV network. The receiver extracts the PCR from the data stream and compares it with a receiver System Time Clock (STC). The receiver STC is initialized by a prior PCR value and controlled by the receiver clock (or some multiple thereof). The magnitude of a difference between the current value of the PCR and the current value of the receiver STC is used to adjust the frequency of the receiver clock.

The transmitter can use a transmitter STC (or some multiple thereof) to generate a transmitter clock. Alternatively, the transmitter can use a PCR to adjust the transmitter clock. For example, the transmitter compares the PCR with the transmitter STC which is initialized with a prior PCR value and controlled by the transmitter clock (or some multiple thereof). The magnitude of a difference between the current value of the PCR and the transmitter STC is used to adjust the frequency of the transmitter clock.

In a digital CATV network, multiple video channels are sent downstream from a headend to subscribers. In one embodiment, each analog video channel is independently digitized by a respective ADC at the transmitter. The digitized video channel is framed into a standard digital format. The framed video channels are combined into one data stream by a multiplexer using time division multiplexing and typically transmitted to the receiver at a node via a fiber optic cable. The data stream is demultiplexed at the receiver back into individual frames representing individual video channels. Two or more channels can be combined in the digital domain after deframing by a bank of modulators using frequency division multiplexing. The combined channels are converted to the analog signals by one DAC.

One or more of the synchronization methods described above can be used to synchronize the transmitter ADCs with the receiver DAC. For example, the transmitter ADCs can be operated from a common clock source. The common clock source also controls one or more of the synchronization mechanisms described above, such as the transmitter counter. Information from the synchronization mechanism is added to the downstream data at the multiplexer. The demultiplexer at the receiver extracts the synchronization information from the downstream data and provides the synchronization information to the receiver's synchronization circuitry. The receiver clock or the downstream data rate is then appropriately adjusted.

The synchronization techniques described above can be similarly applied to upstream data that flows from the subscriber to the CATV network.

### BRIEF DESCRIPTION OF THE DRAWINGS

FIG. 1 is an illustration of a communication system.

FIG. 2 is a block diagram of one embodiment of a transmitter conversion circuit shown in FIG. 1.

FIG. 3 is a block diagram of one embodiment of a receiver conversion circuit shown in FIG. 1.

FIG. 4 is an illustration of a cable television distribution system.

FIG. 5 is a block diagram of one embodiment of a transmitter shown in FIG. 4.

FIG. 6 is a block diagram of one embodiment of a receiver shown in FIG. 4.

FIG. 7 is a block diagram of an alternate embodiment of a transmitter shown in FIG. 4.

FIG. 8 is a block diagram of an alternate embodiment of a receiver shown in FIG. 4.

FIG. 9 is a block diagram of an alternate embodiment of a receiver conversion circuit shown in FIG. 1, which uses clock frequency synchronization techniques.

FIG. 10 is a block diagram of another embodiment of a transmitter conversion circuit shown in FIG. 1, which uses clock recovery techniques.

FIG. 11 is a block diagram of another embodiment of a receiver conversion circuit shown in FIG. 1, which uses clock recovery techniques.

In the figures, the first digit of any three-digit number generally indicates the number of the figure in which the element first appears. When four-digit reference numbers are used, the first two digits generally indicate the figure number.

### DESCRIPTION OF THE INVENTION

The present invention involves synchronization or equalization in a digital communication system wherein digital data is sent from an ADC to a DAC which operate at different clock rates. The ADC clock rate determines a data generation rate (i.e., the rate at which digital data is generated). The DAC clock rate determines a data consumption rate (i.e., the rate at which digital data is converted to an analog signal). In one embodiment, the data generation rate and the data consumption rate are equalized by adjusting the clock rates. In another embodiment, the digital data is resampled to compensate for a difference between the data generation rate and the data consumption rate in the digital communication system.

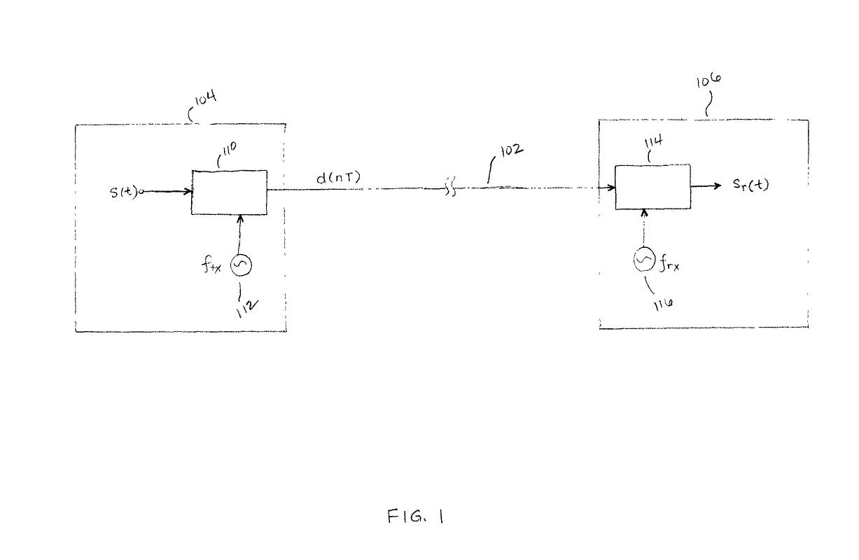

A digital communication system is illustrated in FIG. 1. The digital communication system includes a transmitter 104 and a receiver 106. Information in the analog domain (e.g., time-continuous signals such as speech, music, video, telemetry data, etc.) are sampled and digitized in the transmitter 104 for reliable and secured transmission to the receiver 106. The receiver 106 can convert the digitized information back to the analog domain.

In the transmitter 104, an analog input signal s(t) is provided to a transmitter conversion circuit 110 for conversion to digital bits. A transmitter conversion clock 112, with an operating frequency fₜₓ, is provided to the transmitter conversion circuit 110 to control the rate at which the digital bits are generated (i.e., data generation rate). The digital output d(nT) of the transmitter conversion circuit 100 is provided to a receiver conversion circuit 114 in the receiver 106 via a communication channel 102. The communication channel 102 can be a cable, optical, wireless link, etc.

The receiver conversion circuit 114 converts the digital bits back into a recovered analog signal sᵣ(t). A receiver conversion clock 116, with an operating frequency fᵣₓ, is provided to the receiver conversion circuit 114 to control the rate at which the digital bits are converted back to the analog domain (i.e., data consumption rate).

In one embodiment, the transmitter conversion clock 112 and the receiver conversion clock 116 run independently of each other. If there is a difference in the respective operating frequencies of the transmitter conversion clock 112 and the receiver conversion clock 116, the data generation rate will be different from the data consumption rate. The difference between the data generation rate and the data consumption rate results in a spectral expansion or compression of the digitized information at the receiver 106 (i.e., distortion in the recovered analog signal sᵣ(t)).

The present invention solves this and other problems by sensing the difference between the respective operating frequency of the transmitter conversion clock 112 and the operating frequency of the receiver conversion clock 116 and resampling the digitized data accordingly before conversion back to the analog domain. In another embodiment, clock frequency synchronization techniques or clock recovery techniques synchronize the transmitter conversion clock 112 and the receiver conversion clock 116.

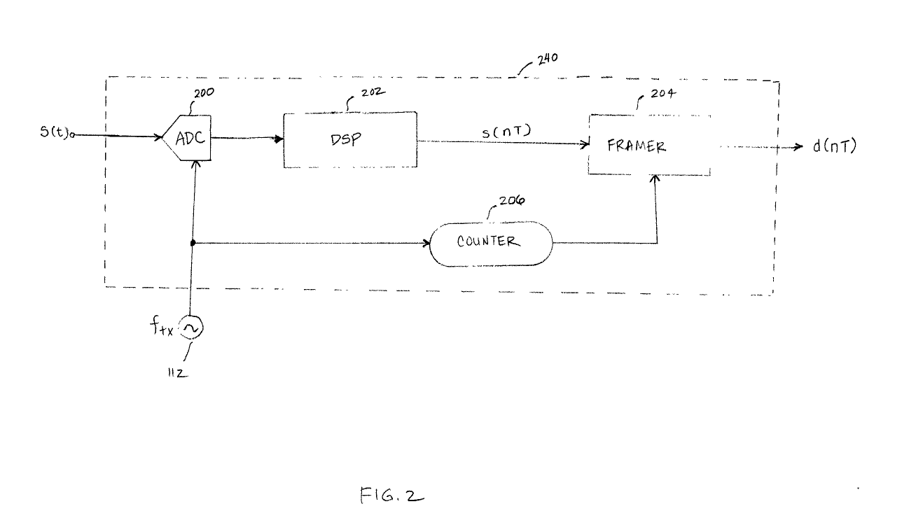

FIG. 2 is a block diagram of a transmitter conversion circuit 240, which is one embodiment of the transmitter conversion circuit 110 which sends an indication of the operating frequency of the transmitter conversion clock 112 to the receiver 106. The analog input signal s(t) is provided to the input of an ADC 200 for conversion into digital bits. The output of the ADC 200 is provided to a Digital Signal Processor (DSP) 202 for further processing, such as digital filtering and the like. The DSP 202 provides a digital signal s(nT) to a framer 204.

The ADC 200 samples and digitizes the analog input signal s(t) at a data generation rate controlled by the transmitter conversion clock 112 (i.e., the ADC clock). The transmitter conversion clock 112 is also provided to a transmitter counter 206. The output of the transmitter counter 206 is provided to the framer 204. The framer 204 outputs a digital signal d(nT) for transmission to the receiver 106 through the communication channel 102.

In one embodiment, the transmitter counter 206 is incremented by the ADC clock 112 (or some multiple thereof), and the changing value of the transmitter counter 206 is used to detect the frequency of the ADC clock 112. In one embodiment, the transmitter counter 206 counts cumulatively and wraps when a maximum number is reached. The maximum number is determined by the number of bits in the transmitter counter 206 and can be varied depending upon the desired resolution in frequency detection. The transmitter cumulative counts (i.e., the transmitter count stamps) are provided to the framer 204 to be sent to the receiver 106 intermittently or periodically with data streams. The framer 204 arranges digital information into a specified format for transmission using a standard protocol through the communication channel 102.

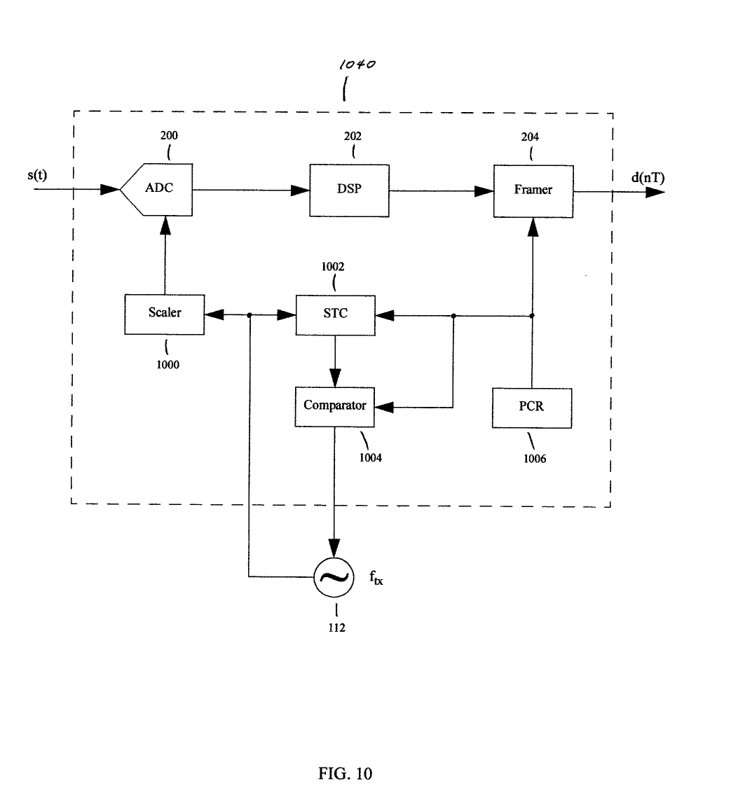

FIG. 10 is a block diagram of a transmitter conversion circuit 1040, which is another embodiment of the transmitter conversion circuit 110 shown in FIG. 1. The analog input signal s(t) is provided to the input of the ADC 200. The output of the ADC 200 is provided to the DSP 202. The output of the DSP is provided to the framer 204.

The output of a Program Clock Reference (PCR) 1006 is provided to the framer 204, a transmitter System Time Clock (STC) 1002, and a comparator 1004. The ADC clock 112 is provided to a scaler 1000 and the transmitter STC 1002. The scaler 1000 controls the ADC 200. An output of the transmitter STC 1002 is provided to the comparator 1004. An output of the comparator 1004 controls the ADC clock 112.

The transmitter conversion circuit 1040 uses a clock recovery techniques to synchronize the ADC clock 112 to a clock in the receiver 106. The PCR 1006 is a clock reference generated at the transmitter 104. The output of the PCR 1006 is provided to the framer 204 for transmission to the receiver 106. The receiver 106 can use the PCR 1006 to adjust its clocks.

In one embodiment, the transmitter 104 uses the transmitter STC 1002 (or some multiple thereof) to generate the ADC clock 112. In another embodiment, the transmitter 104 uses the PCR 1006 to adjust the ADC clock 112. For example, the transmitter STC 1002 is initialized with a prior PCR value and controlled by the ADC clock 112 (or some multiple thereof). The comparator 1004 compares the current value of the transmitter STC and the current value of the PCR 1006. The magnitude of a difference between the current values is used to adjust the frequency of the ADC clock 112. In one embodiment, the ADC clock 112 is provided to the scaler 1000 to scale the frequency of the ADC clock 112 by an integer factor.

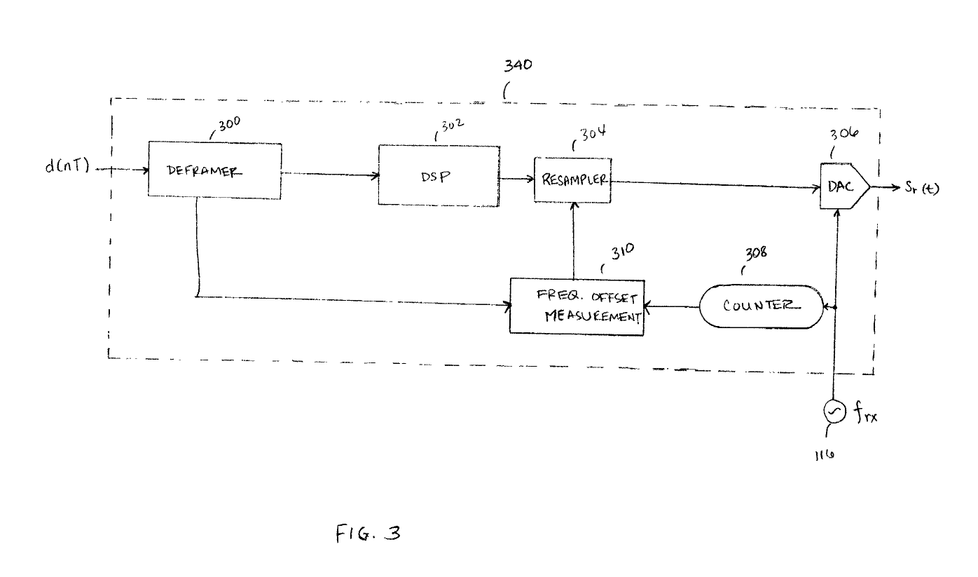

FIG. 3 is a block diagram of a receiver conversion circuit 340, which is one embodiment of the receiver conversion circuit 114 which resamples digital data to compensate for a difference between the respective operating frequencies of the ADC clock 112 and the receiver conversion clock 116. In one embodiment, the digital signal d(nT), including the digital data and the frequency indication of the ADC clock 112, is received from the transmitter 104 and provided to a deframer 300. The deframer 300 separates the transmitter cumulative count from the data stream and sends the transmitter cumulative count to a frequency offset measurement circuit 310 (i.e., control circuit) while sending the data stream to a DSP 302. The output of the DSP 302 is provided to a resampler 304. The output of the resampler 304 is provided to a DAC 306 which outputs the recovered analog signal sᵣ(t).

The DAC 306 converts digitized information back into the analog domain at a rate controlled by the receiver conversion clock 116 (i.e., the DAC clock). The DAC clock 116 is also provided to a receiver counter 308. In one embodiment, the receiver counter 308 is incremented by the DAC clock 116 (or some multiple thereof), and the changing value of the receiver counter 308 can be used to detect the frequency of the DAC clock 116. The receiver counter 308 counts cumulatively and wraps when a maximum number is reached. The maximum number is determined by the number of bits in the receiver counter 308 and can be varied depending upon the desired resolution in frequency detection. The receiver cumulative counts (i.e., receiver count stamps) are provided to the frequency offset measurement circuit 310. The output of the frequency offset measurement circuit 310 controls the resampler 304.

In one embodiment, resampling compensates for a disparity between the ADC clock 112 and the DAC clock 116. The resampler 304 receives input data from the DSP 302 at one rate and generates output data to the DAC 306 at another rate. The frequency offset measurement circuit 310 provides a control word, a control signal, or a control count to control the ratio of the input data rate to the output data rate of the resampler 304.

Resampling involves decimation and/or interpolation of data. For example, if the ADC clock 112 runs faster than the DAC clock 116, the resampler 304 decimates the input data. Similarly, if the ADC clock 112 runs slower than the DAC clock 116, the resampler 304 interpolates the input data. Proper resampling (i.e., data rate adjustment) avoids a shortage or an excess of digital samples at the input of the DAC 306 when the frequencies of the ADC clock 112 and the DAC clock 116 differ.

In one embodiment, the frequency offset measurement circuit 310 outputs a control word to the resampler 304 based on a difference between the transmitter count stamp and the receiver count stamp. The difference between the count stamps provides an indication of the difference in frequency between the ADC clock 112 and the DAC clock 116.

For example, the frequency offset measurement circuit 310 compares a current transmitter count stamp with a current receiver count stamp. When the ADC clock 112 is synchronous with the DAC clock 116, the difference between the current count stamps is zero or a fixed amount each time. Channel delay (i.e., amount of time it takes for data to travel from the transmitter 104 to the receiver 106) is assumed to be relatively consistent over time. Alternatively, the channel delay is relatively insignificant in comparison to long term observations of differences in count stamps.

When the respective frequencies of the ADC clock 112 and the DAC clock 116 are different from each other, the differences between the count stamps vary over time. The variation of the differences between the count stamps provides indications of the frequency differences between the ADC clock 112 and the DAC clock 116 over time. The integral error (i.e., cumulative long-term effect) of slight frequency differences becomes significant over time. Therefore, the count stamps can provide very accurate indications of frequency differences after a sufficient amount of time.

In another embodiment, the frequency offset measurement circuit 310 compares a current transmitter count stamp with a previous transmitter count stamp stored in memory. The frequency offset measurement circuit 310 similarly compares a current receiver count stamp with a previous receiver count stamp stored in memory.

When the ADC clock 112 is synchronous with the DAC clock 116, the rates of change in the respective count stamps are the same. When the ADC clock 112 and the DAC clock 116 differ from each other, the rates of change in the respective count stamps drift apart. The amount of drift between the rates of change corresponds to the amount of frequency difference between the ADC clock 112 and the DAC clock 116. Accordingly, the frequency offset measurement circuit 310 derives a control word for the resampler 304 based on the difference between the rate of change in the transmitter count stamp and the rate of change in the receiver count stamp.

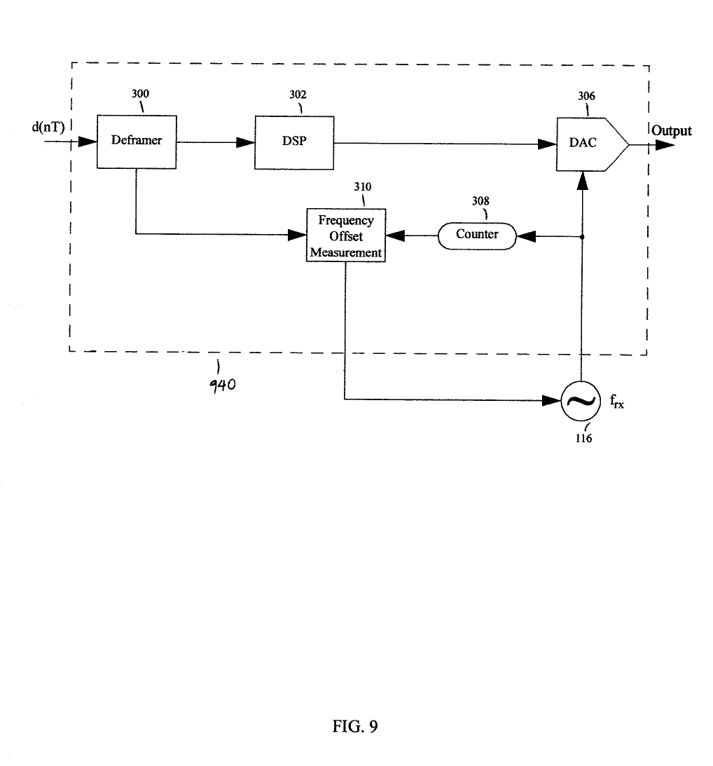

FIG. 9 is a block diagram of a receiver conversion circuit 940, which is an alternate embodiment of the receiver conversion circuit 114 shown in FIG. 1. The receiver conversion circuit 940 uses clock frequency synchronization to compensate for differences between a transmitter clock and a receiver clock over time. A digital signal d(nT), including digital data and a frequency indication (e.g., a transmitter time stamp) of the ADC clock 112 in the transmitter 104, is received from the transmitter 104 and provided to a deframer 300. The deframer 300 separates the transmitter time stamp from the digital data and sends the transmitter time stamp to a frequency offset measurement circuit 310. The digital data is provided to a DSP 302 for further processing. The output of the DSP 302 is provided to a DAC 306.

A DAC clock 116 controls the DAC 306 and a receiver counter 308. The receiver counter 308 produces a receiver time stamp indicative of the frequency of the DAC clock 116. The output of the receiver counter 308 is provided to the frequency offset measurement circuit 310. The frequency offset measurement circuit 310 compares the transmitter time stamp and the receiver time stamp in similar methods as described above to determine an amount of adjustment to the frequency of the DAC clock 116. For example, the frequency of the DAC clock 116 is increased when the transmitter time stamp increases at a faster rate than the receiver time stamp, and the DAC clock 116 is decreased when the transmitter time stamp increases at a slower rate than the receiver time stamp.

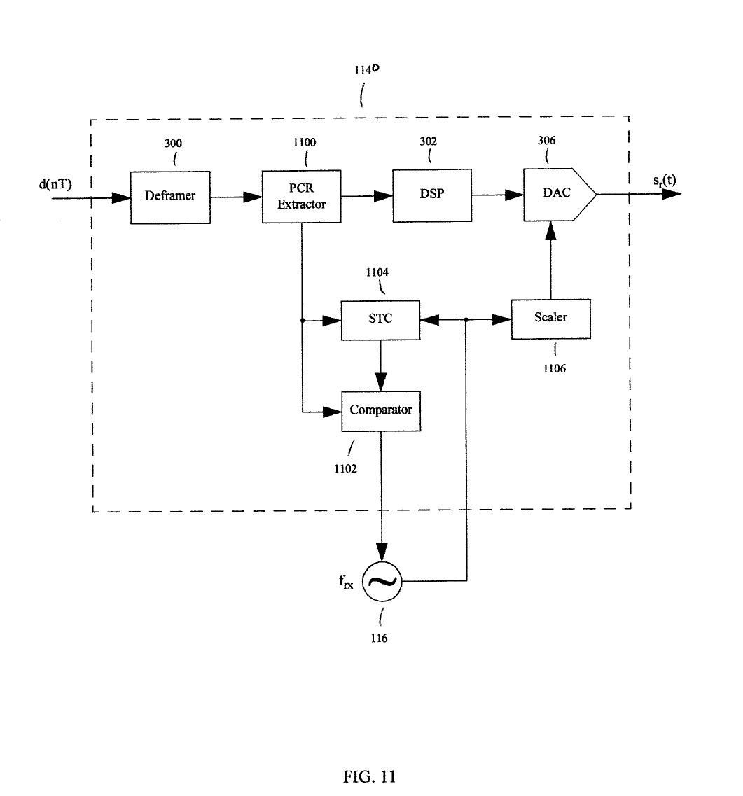

FIG. 11 is a block diagram of a receiver conversion circuit 1140, which is another embodiment of the receiver conversion circuit 114 shown in FIG. 1. The receiver conversion circuit 1140 uses clock recovery techniques to synchronize a clock in the transmitter 104 with a clock in the receiver 106.

A digital signal d(nT), including digital data and a frequency indication (e.g., a PCR signal) of the ADC clock 112 in the transmitter 104, is received from the transmitter 104 and provided to a deframer 300. The output of the deframer 300 is provided to a PCR extractor which separates the PCR signal from the digital data and sends the PCR signal to a receiver STC 1104 and a comparator 1102. The digital data is provided to a DSP 302 for further processing. The output of the DSP 302 is provided to a DAC 306.

A DAC clock 116 controls the DAC 306. In one embodiment, the DAC clock 116 is provided to a scaler 1106, which is coupled to the DAC 306. The scaler 1106 scales the frequency of the DAC clock 116 by an integer multiple. The DAC clock 116 is also provided to the receiver STC 1104. The receiver STC 1104 is initialized by a prior PCR signal and updated by the DAC clock 116 (or some multiple thereof). The output of the receiver STC 1104 is provided to the comparator 1102. The comparator 1102 compares the PCR signal with the current value of the receiver STC 1104. The magnitude of a difference between the PCR signal and the current value of the receiver STC 1104 is used to adjust the frequency of the DAC clock 116 to follow the frequency of the ADC clock 112.

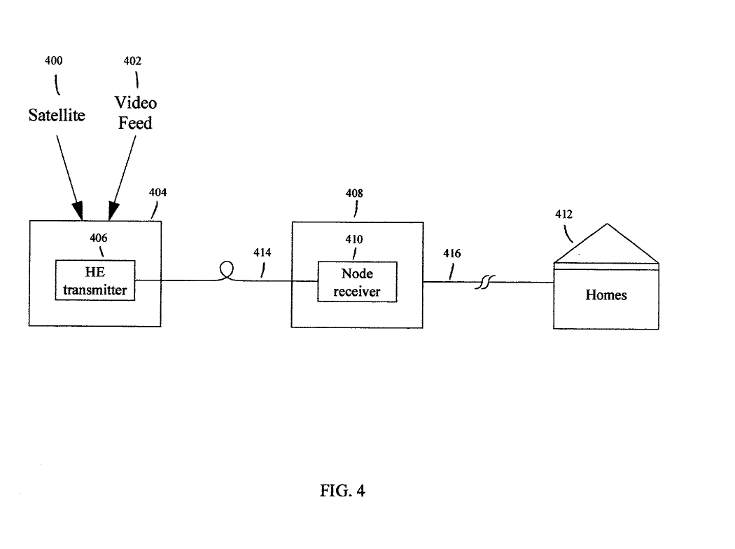

The synchronization techniques described above can be applied in a cable television distribution system as illustrated in FIG. 4. Data from various sources, such as signals received from a satellite 400 or signals from a video feed 402, are received at a headend 404. The headend 404 prepares the received information for transmission to at least one node 408, which then passes the information to homes 412 (i.e., subscribers). Fiber optic cables 414 are typically used in transmission paths between the headend 404 and the node 408, while coaxial cables 416 are typically used in transmission paths between the node 408 and the homes 412.

In one embodiment, a transmitter 406 in the headend 404 samples and digitizes analog video channels for transmission to a receiver 410 in the node 408. The receiver 410 converts the digitized video channels back to the analog domain before broadcasting the video channels to the homes 412.

In a digital CATV network, multiple video channels are sent downstream from a headend 404 to the homes 412 (i.e., subscribers). In one embodiment, each analog video channel is independently digitized by a respective ADC at the transmitter 406. The digitized video channel is framed into a standard digital format. The framed video channels are combined into one data stream by a multiplexer using time division multiplexing and typically transmitted to the receiver 410 at a node 408 via a fiber optic cable 414. The data stream is demultiplexed at the receiver 410 back into individual frames representing individual video channels. Two or more channels can be combined in the digital domain after deframing by a bank of modulators using frequency division multiplexing. The combined channels are converted to the analog signals by one DAC.

One or more of the synchronization methods described above can be used to synchronize the transmitter ADCs with the receiver DAC. For example, the transmitter ADCs can be operated from a common clock source. The common clock source also controls one or more of synchronization mechanisms, such as a transmitter counter. Information from the synchronization mechanisms is added to the downstream data at the multiplexer. The demultiplexer at the receiver 410 extracts the synchronization information from the downstream data and provides the synchronization information to a receiver's synchronization circuitry. The receiver clock or the downstream data rate is then appropriately adjusted.

The synchronization techniques described above can be similarly applied to upstream data that flows from the subscribers 412 to the CATV network.

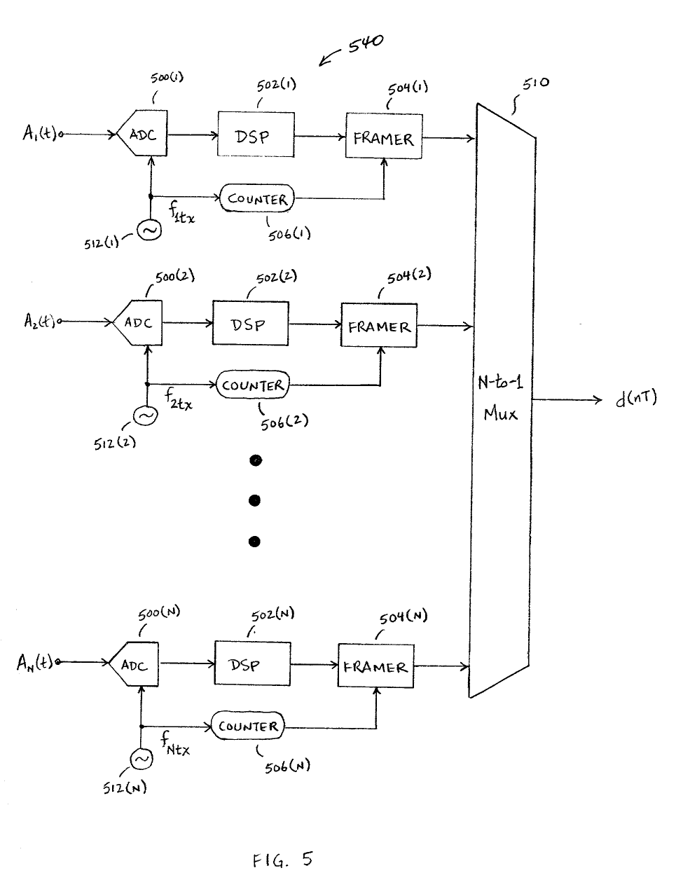

FIG. 5 is a block diagram of a transmitter 540, which is one embodiment of the transmitter 406 shown in FIG. 4. In the transmitter 540, analog video channels Aᵢ(t) are processed by N respective ADCs shown as ADCs 500(l)-500(N) (collectively the ADCs 500), followed by N respective DSPs shown as DSPs 502(1)-502(N) (collectively the DSPs 502) and N respective framers shown as framers 504(l)-504(N) (collectively the framers 504).

The analog video channels have respective bandwidths of approximately 6 MHz each. The ADCs 500 are controlled by N respective ADC clocks shown as ADC clocks 512(1)-512(N) (collectively the ADC clocks 512). In one embodiment, the ADC clocks 512 function independently of each other. Accordingly, the ADC clocks 512 increment N respective transmitter counters shown as transmitter counters 506(1)-506(N) (collectively the transmitter counters 506).

The outputs of the transmitter counters 506 are provided to the respective framers 504 for transmission to the receiver 410. The framers 504 arrange the digitized data corresponding to each analog video channel in a specified order. The framers 504 also add values (i.e., transmitter time stamps) of the respective transmitter counters 506 periodically or intermittently. The outputs of the respective framers 504 are provided to inputs of a multiplexer 510. In one embodiment, the multiplexer 510 uses time division multiplexing to combine the outputs of the framers 504 into one transport stream for transmission to the receiver 410.

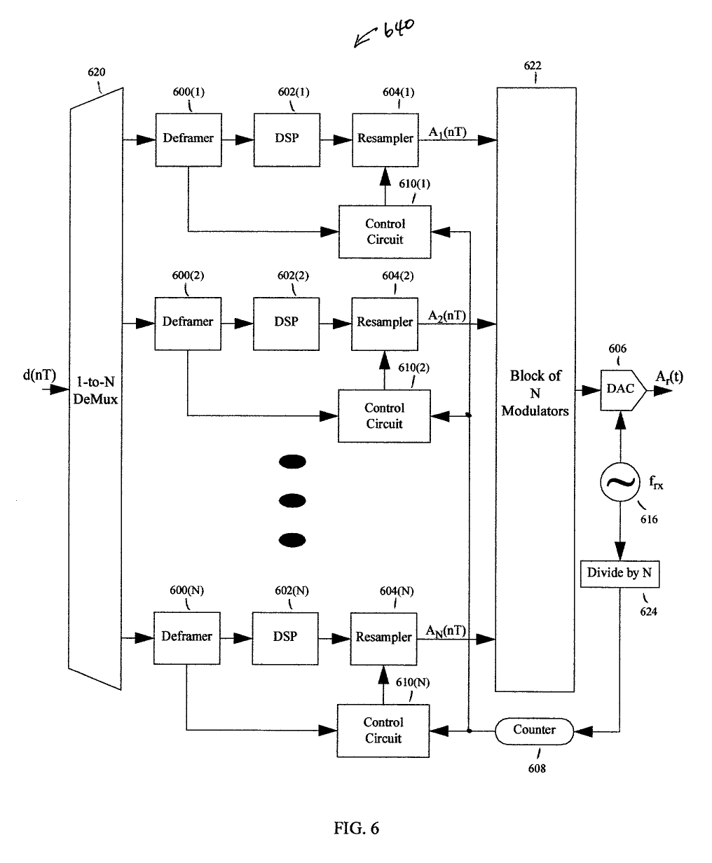

FIG. 6 is a block diagram of a receiver 640, which is one embodiment of the receiver 410 shown in FIG. 4. The receiver 640 can recover multiple analog and/or digital video signals from one transport stream. The receiver 640 includes a demultiplexer 620 which separates the incoming transport stream into individual streams of frames. The individual streams are provided to N respective deframers shown as deframers 600(1)-600(N) (collectively the deframers 600). The deframers 600 extract the respective transmitter time stamps during the deframing process which recovers the digitized data (i.e., payload). The deframers 600 provide the transmitter time stamps to N respective control circuits shown as control circuits 610(1)-610(N) (collectively the control circuits 610).

The deframers 600 provide the recovered digitized data corresponding to each analog video channel to N respective DSPs shown as DSPs 602(1)-602(N) (collectively the DSPs 602). The outputs of the DSPs 602 are provided to N respective resamplers shown as resamplers 604(1)-604(N) (collectively the resamplers 604). The outputs of the resamplers 604 are provided to a modulator block 622 for combination using frequency division multiplexing. The combined digital signal is provided to a DAC 606 for conversion into a broadband analog signal Ar(t) which can be further processed and broadcast to the homes 412.

A DAC clock 616 controls the operation of the DAC 606. In one embodiment, the DAC clock 616 is provided to a divider 624 before being provided to a receiver counter 608. Thus, the receiver counter 608 is being incremented by a clock derived from the DAC clock 616. The output of the receiver counter 608 is provided to each of the control circuits 610. The control circuits 610 output appropriate control words to the respective resamplers 604 using techniques described above.

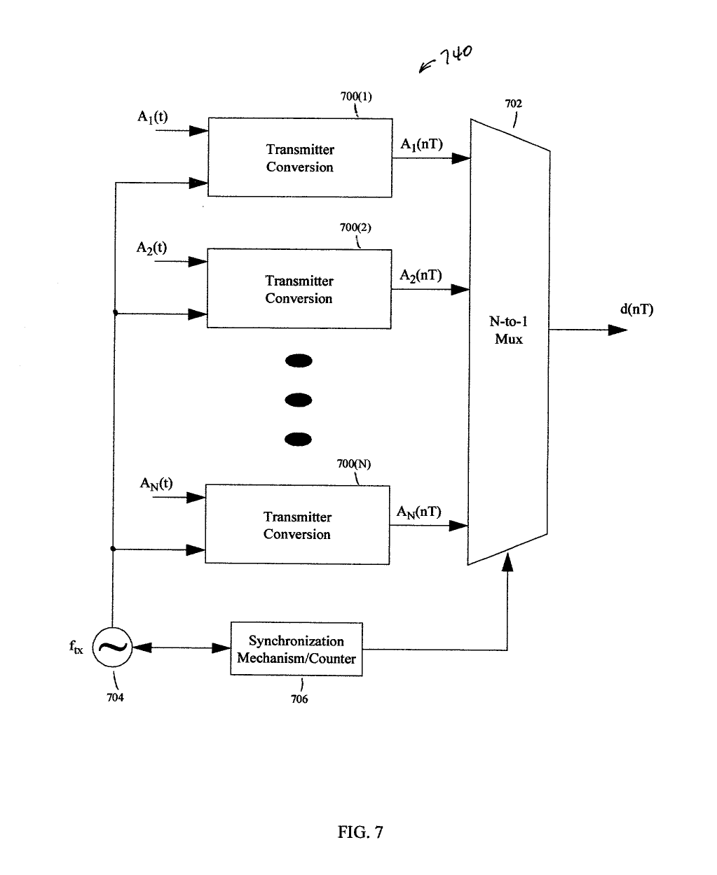

FIG. 7 is a block diagram of a transmitter 740, which is an alternate embodiment of the transmitter 406 shown in FIG. 4. In the transmitter 740, analog video channels Aᵢ(t) are processed by N respective transmitter conversion circuits shown as transmitter conversion circuits 700(1)-700(N) (collectively the transmitter conversion circuits 700). The transmitter conversion circuits 700 are controlled by a common transmitter clock 704. The transmitter clock 704 also controls a transmitter synchronization circuit 706 (e.g., a transmitter counter). In one embodiment, the transmitter synchronization circuit 706 adjusts the frequency of the common transmitter clock 704 using the clock recovery techniques described above.

The outputs the transmitter conversion circuits 700 are provided to a multiplexer 702. In one embodiment, the multiplexer 510 uses time division multiplexing to combine the outputs of the transmitter conversion circuits 700 and the output (i.e., transmitter time stamp) from the transmitter synchronization circuit 706 into one transport stream for transmission to the receiver 410. The transmitter time stamp provides an indication of the frequency of the common transmitter clock 704 to the receiver 410.

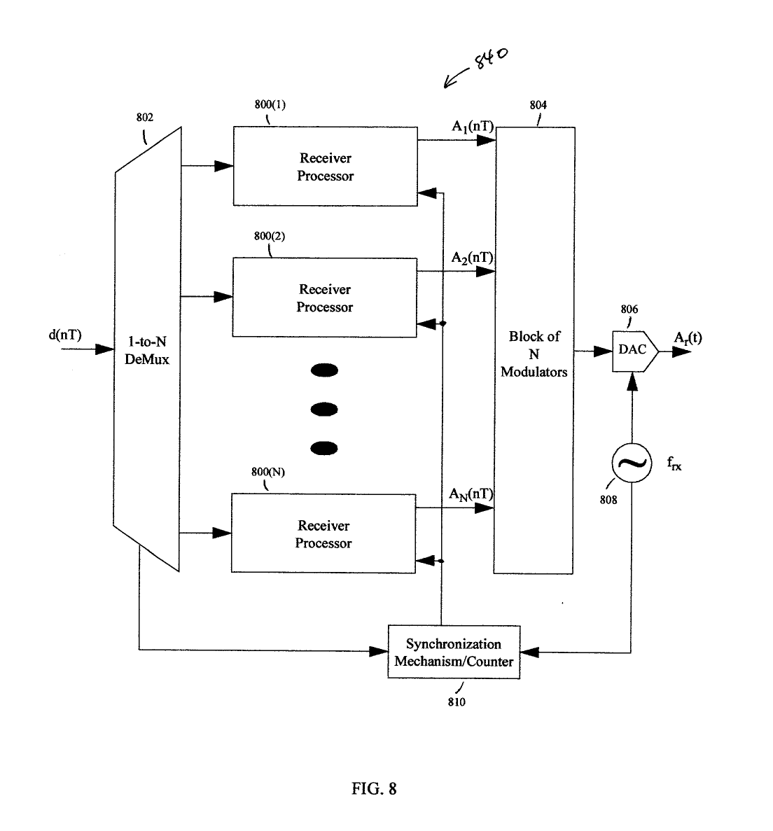

FIG. 8 is a block diagram of a receiver 840, which is an alternate embodiment of the receiver 410 shown in FIG. 4. The receiver 840 includes a demultiplexer 802 which separates the incoming transport stream into individual data streams and extracts the transmitter time stamp. The transmitter time stamp is provided to a receiver synchronization circuit 810. The individual streams are provided to N respective receiver processors shown as receiver processors 800(1)-800(N) (collectively the receiver processors 800). The outputs of the receiver processors 800 are provided to a modulator block 804 for combination using frequency division multiplexing. The combined digital signal is provided to a DAC 806 for conversion into a broadband analog signal Aᵣ(t) which can be further processed and broadcast to the homes 412.

A DAC clock 808 controls the operation of the DAC 806. In one embodiment, the DAC clock 808 is provided to the receiver synchronization circuit 810. For example, the DAC clock 808 (or some multiple thereof) can increment a counter in the receiver synchronization circuit 810. In one embodiment, the receiver synchronization circuit 810 outputs an appropriate control signal to the receiver processors 800 using the data rate equalization techniques described above. The receiver processor 800 include respective resampling circuits for adjusting data rates of digitized information.

In another embodiment, the receiver synchronization circuit 810 adjusts the frequency of the DAC clock 808 in accordance with the clock frequency synchronization techniques or the clock recovery techniques described above. In the particular embodiments described above, the synchronization techniques are applied to a forward path of the cable television distribution system. The synchronization techniques can also be used to synchronize the cable reverse path (i.e., upstream network) from the homes 412 to the headend 404.

Although described above in connection with particular embodiments of the present invention, it should be understood that the descriptions of the embodiments are illustrative of the invention and are not intended to be limiting. Various modifications and applications may occur to those skilled in the art without departing from the true spirit and scope of the invention as defined in the appended claims.

What is claimed is:

1. A digital cable television network comprising:
a transmitter comprising:
an analog-to-digital converter configured to receive an analog video signal and produce corresponding digital values at a rate determined by a transmitter clock; and
a transmitter synchronizer coupled to said transmitter clock and configured to produce a time signal indicative of the transmitter clock frequency, said transmitter synchronizer comprising a first counter incremented by a multiple of said transmitter clock; and
a receiver comprising:
a digital-to-analog converter configured to receive said analog video signal represented by said digital values and to produce analog equivalents at a rate determined by a receiver clock; and
a receiver synchronizer coupled to said receiver clock and configured to receive said time signal for comparison and adjustment of receiver operation to account for a difference between the transmitter clock frequency and the receiver clock frequency, said receiver synchronizer comprising a second counter and a comparator, said second counter incremented by a multiple of said receiver clock, and said comparator configured to receive inputs from said first counter and said second counter and to produce control information indicative of a difference in rates of change of the respective first and second counters.

2. The digital cable television network of claim 1 wherein said transmitter resides at a headend and said receiver resides at a node.

3. The digital cable television network of claim 1 wherein said transmitter resides at a node and said receiver resides at a headend.

4. The digital cable television network of claim 1 wherein said receiver further comprises a resampler configured to receive said control information and change a data rate of said analog video signal represented by said digital values.

5. The digital cable television network of claim 1 wherein said receiver synchronizer adjusts the receiver clock frequency with said control information.

6. A digital cable television network comprising:
a transmitter comprising:
an analog-to-digital converter configured to receive an analog video signal and to produce corresponding digital values at a rate determined by a transmitter clock; and
a transmitter synchronizer coupled to said transmitter clock and configured to produce a time signal indicative of the transmitter clock frequency, said transmitter synchronizer comprising a program clock reference, a first system time clock controlled by said transmitter clock, and a first comparator configured to compare values of said program clock reference with said first system time clock and adjust said transmitter clock based on a difference; and
a receiver comprising:
a digital-to-analog converter configured to receive said analog video signal represented by said digital values and to produce analog equivalents at a rate determined by a receiver clock; and
a receiver synchronizer coupled to said receiver clock and configured to receive said time signal for comparison and adjustment of receiver operation to account for differences between the transmitter clock frequency and the receiver clock frequency, said receiver synchronizer comprising an extractor, a second system time clock and a second comparator, said extractor configured to extract value of said program clock reference from data stream sent by said transmitter, said second system time clock controlled by said receiver clock, and said second comparator configured to compare values of said program clock reference and said second system time clock and adjust said receiver clock based on a difference.

7. A method of synchronizing a transmitter and a receiver in a digital cable television network comprising the acts of:
comparing a first count with a second count, wherein said first count is representative of a transmitter data rate and said second count is representative of a receiver data rate;
producing control information for a resampler based on said comparison;
and
resampling digital data produced by said transmitter in accordance with said control information before converting said digital data to an analog equivalent in the receiver.

8. The method of synchronizing a transmitter and a receiver in a digital cable television network of claim 7, further comprising the acts of:
generating said first count at said transmitter using a transmitter clock;
inserting value of said first count into a data stream at the transmitter;
and
extracting said value of said first count from the data stream at the receiver.

9. The method of claim 8, wherein the value of the first count is inserted into the data stream during framing at the transmitter, and the value of the first count is extracted from the data stream during deframing at the receiver.

10. A method of synchronizing a transmitter and a receiver in a digital cable television network comprising the acts of:
comparing a first count with a second count, wherein said first count is representative of a transmitter data rate and said second count is representative of a receiver data rate;
producing control information based on said comparison; and
adjusting a receiver clock in accordance with said control information.

11. The method of synchronizing a transmitter and a receiver in a digital cable television network of claim 10, further comprising the acts of:
generating said first count at said transmitter using a transmitter clock;
inserting value of said first count into a data stream at the transmitter;
and
extracting said value of said first count from the data stream at the receiver.

12. The method of claim 11, wherein the value of the first count is inserted into the data stream during framing at the transmitter, and the value of the first count is extracted from the data stream during deframing at the receiver.

13. A method of synchronizing a transmitter and a receiver in a digital cable television network comprising the acts of:
adjusting a transmitter clock frequency to follow a program clock reference frequency in the transmitter;
sending a signal indicative of said program clock reference frequency to the receiver; and
adjusting a receiver clock frequency based on said signal.

14. The method of claim 13, wherein the signal is inserted into a data stream at the receiver, and the signal is extracted from the data stream at the receiver.

15. The method of claim 14, wherein the signal is inserted into the data stream during framing, and the signal is extracted during deframing.

16. A digital cable television network comprising:
means for digitizing analog signals at a first data rate;
means for producing a first count that is representative of said first data rate;
means for producing a second count that is representative of a second data rate; and
means for converting said digitized analog video signals from said first data rate to said second data rate based on a comparison of said first count and said second count.

17. A digital cable television network comprising:
means for digitizing analog signals at a first data rate;
means for producing a first count that is representative of said first data rate;
means for producing a second count that is representative of a second data rate; and
means for adjusting said second data rate based on a comparison of said first count and said second count.

18. A digital cable television network comprising:
means for digitizing analog video signals at a first data rate;
means for producing a reference clock;
means for adjusting said first data rate based on said reference clock;
means for processing said digitized analog video signals at a second data rate; and
means for adjusting said second data rate based on value of said reference clock.
